(19) United States
(12) Patent Application Publication
(10) Pub. No.: US 2025/0294367 A1
(43) Pub. Date: Sep. 18, 2025

(54) TRANSMISSION COORDINATION BETWEEN BASIC SERVICE SETS

(71) Applicant: Cisco Technology, Inc., San Jose, CA (US)

(72) Inventors: Brian D. HART, Sunnyvale, CA (US); Binita GUPTA, San Diego, CA (US); Malcolm M. SMITH, Richardson, TX (US)

(21) Appl. No.: 19/080,520

(22) Filed: Mar. 14, 2025

Related U.S. Application Data
(60) Provisional application No. 63/566,047, filed on Mar. 15, 2024.

(51) Int. Cl. H04W 16/14; H04W 48/08

(52) U.S. Cl. CPC H04W 16/14; H04W 48/08

(57) ABSTRACT

The present disclosure describes a system that coordinates transmissions between BSSs. A first access point assigned to a first basic service set includes a memory and a processor. The memory stores a data structure that includes a first entry. The first entry indicates (i) a second access point assigned to a second basic service set different from the first basic service set, (ii) a first message at the second access point that has not been transmitted. The processor refrains, based on the first entry, from transmitting a second message for a period of time and in response to detecting that the second access point transmitted the first message, updates the first entry to indicate that the first message has been transmitted. The processor also transmits, to the second access point, a third message indicating that the first message has been transmitted.

### CROSS-REFERENCE TO RELATED APPLICATIONS

This application claims benefit of co-pending U.S. provisional patent application Ser. No. 63/566,047 filed Mar. 15, 2024. The aforementioned related patent application is herein incorporated by reference in its entirety.

### TECHNICAL FIELD

Embodiments presented in this disclosure generally relate to wireless communications. More specifically, embodiments disclosed herein relate to transmission coordination between basic service sets (BSSs).

### BACKGROUND

Wireless networks may be deployed in environments or settings with other wireless networks nearby. For example, in shopping malls, stores are positioned near each other, and these stores may each deploy separate wireless networks that belong to different BSSs. The signals in these networks, however, may propagate beyond their intended recipients (e.g., the boundaries of the stores) and cause interference with communication links in neighboring stores. As a result, the wireless networks may experience reduced performance.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system for coordinating traffic between BSSs.

FIG. 2 illustrates an example operation performed by the system of FIG. 1.

FIG. 3 illustrates an example operation performed by the system of FIG. 1.

FIGS. 4A through 4D illustrate example entries in the system of FIG. 1.

FIGS. 4E and 4F illustrate example mappings in the system of FIG. 1.

FIGS. 5A through 5C illustrate example data structures in the system of FIG. 1.

FIG. 6 is a flowchart of an example method performed by the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a system that coordinates transmissions between BSSs. According to an embodiment, a first access point assigned to a first basic service set includes one or more memories and one or more processors communicatively coupled to the one or more memories. The one or more memories, individually or collectively, store a data structure that includes a first entry. The first entry indicates (i) a second access point assigned to a second basic service set different from the first basic service set, (ii) a first message at the second access point that has not been transmitted. The one or more processors, individually or collectively, perform an operation that includes refraining, based on the first entry, from transmitting a second message for a period of time and in response to detecting that the second access point transmitted the first message, updating the first entry to indicate that the first message has been transmitted. The operation also includes transmitting, to the second access point, a third message indicating that the first message has been transmitted.

According to another embodiment, a method includes storing, by a first access point assigned to a first basic service set, a data structure that includes a first entry. The first entry indicates (i) a second access point assigned to a second basic service set different from the first basic service set, (ii) a first message at the second access point that has not been transmitted. The method also includes refraining, by the first access point and based on the first entry, from transmitting a second message for a period of time and in response to detecting that the second access point transmitted the first message, updating, by the first access point, the first entry to indicate that the first message has been transmitted. The method further includes transmitting, by the first access point and to the second access point, a third message indicating that the first message has been transmitted.

According to another embodiment, a non-transitory computer readable medium stores instructions that, when executed by one or more processors, cause the one or more processors to, individually or collectively, perform an operation that includes storing, by a first access point assigned to a first basic service set, a data structure comprising a first entry. The first entry indicates (i) a second access point assigned to a second basic service set different from the first basic service set, (ii) a first message at the second access point that has not been transmitted. The operation also includes refraining, by the first access point and based on the first entry, from transmitting a second message for a period of time, in response to detecting that the second access point transmitted the first message, updating, by the first access point, the first entry to indicate that the first message has been transmitted, and transmitting, by the first access point and to the second access point, a third message indicating that the first message has been transmitted.

### Example Embodiments

The present disclosure describes a system that includes wireless networks that coordinate transmissions across different basic service sets (BSSs). Generally, the access points in a network maintain a data structure (e.g., a scoreboard) that tracks the transmissions (which may also be referred to service periods) of access points in other BSSs. When an access point makes a transmission, the access point may inform nearby access points in other BSSs that the transmission has been made. These access points may then update their data structures to reflect that the transmission has been made. In this manner, the access points in different BSSs may use the data structures to track and monitor the state of the transmission medium. For example, the access points may determine what messages from other BSSs have been transmitted or are still awaiting transmission. These access points may coordinate their transmissions using their local instance of the data structure, and this coordination activity reduces the interference between the access points even though the access points service different BSSs.

In certain embodiments, the system provides several technical advantages. For example, the system may experience reduced interference between access points assigned to different BSSs and may experience low latency traffic across the system being delivered promptly with higher reliability by coordinating the transmissions across the BSSs.

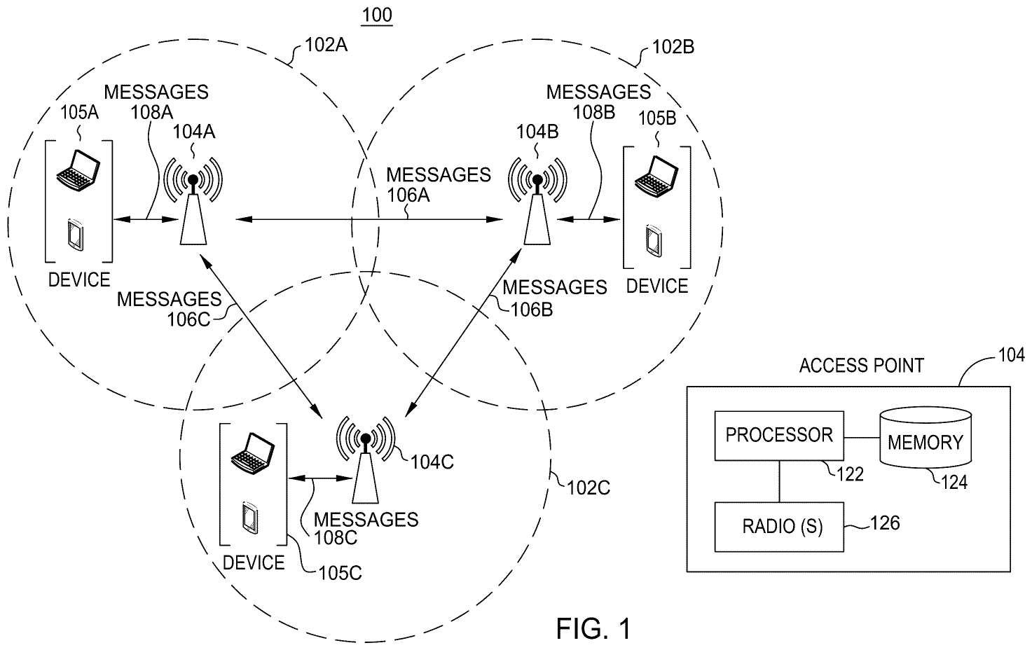

FIG. 1 illustrates an example system 100 for coordinating traffic between BSSs. As seen in FIG. 1, the system 100 includes BSSs 102, access points 104, and devices 105. Generally, the access points 104 may service the devices 105 in different BSSs 102, and the access points 104 may coordinate their transmissions with access points 104 in another BSS 102. In certain embodiments, by coordinating transmissions, the system 100 reduces interference between BSSs and aids in delivering latency-sensitive traffic promptly with higher reliability.

In the example of FIG. 1, the system 100 includes a BSS 102A, a BSS 102B, a BSS 102C, an access point 104A, an access point 104B, and an access point 104C. The access point 104A services a device 105A in the BSS 102A. The access point 104B services a device 105B in the BSS 102B. The access point 104C services a device 105C in the BSS 102C. For example, the access point 104A may transmit messages to and receive messages from the device 105A in the BSS 102A, and the access point 104B may transmit messages to and receive messages from the device 105B in the BSS 102B.

The BSSs 102A, 102B, and 102C and the access points 104A, 104B, and 104C may be deployed physically or geographically close to each other. For example, the access points 104A, 104B, and 104C may be deployed in stores that are near each other to implement the BSSs 102A, 102B, and 102C. Due to the proximity of the access points 104A, 104B, and 104C to each other, when the access points 104A, 104B, and 104C transmit to devices 105 within their respective BSSs 102A, 102B, and 102C, the transmissions may extend into other BSSs 102A, 102B, and 102C and interfere with the transmissions of another access point 104A, 104B, and 104C.

The access points 104A, 104B, and 104C may communicate messages 106 to each other (e.g., using a secure communications channels) to coordinate their transmissions. The messages 106A may be exchanged between the access points 104A and 104B. The messages 106B may be exchanged between the access points 104B and 104C. The messages 106C may be exchanged between the access points 104A and 104C. Each access point 104A, 104B, and 104C may maintain a data structure (e.g., a scoreboard) that tracks the communication state of the access points 104 in the system 100. The data structure may include entries that indicate the traffic or messages (which may be scheduled for certain service periods) that have been transmitted by the access points 104 and that are awaiting transmission by the access points 104. The access points 104A, 104B, and 104C may negotiate and agree to an ordering for the messages awaiting transmission. The access points 104A, 104B, and 104C may then transmit messages according to the ordering. When one of the access points 104A, 104B, or 104C is transmitting, the other access points may refrain from transmitting to avoid interfering with the transmitting access point. In some embodiments, the other access points may refrain from transmitting (or causing devices in the same BSSs as the other access points from transmitting) for a period of time. The period of time may end when a particular event occurs. For example, the period of time may end when the other access points determines that the access point 104A, 104B, or 104C has finished transmitting one or more messages (e.g., completed a service period).

The access points 104A, 104B, and 104C may then transmit messages 108 to devices 105 according to negotiated ordering. For example, the access point 104A may transmit messages 108A to and from the device 105A. The access point 104B may transmit messages 108B to and from the device 105B. The access point 104C may transmit messages 108C to and from the device 105C. The messages 108A, 108B, and 108C may include data messages and/or management messages. After the access points 104A, 104B, and 104C transmit a message 108, the access points 104A, 104B, and 104C also communicates messages 106 to each other to indicate that the message 108 has been transmitted. The access points 104A, 104B, and 104C may then use these messages 106 to update their respective data structures to indicate that the messages 108 have been transmitted. In this manner, the access points 104A, 104B, and 104C update their data structures to reflect the state of the communications in the system 100.

In certain embodiments, the access points 104A, 104B, and 104C negotiate and agree to an ordering for groups of messages 108 awaiting transmission, which may be referred to as service periods. Each service period may involve one or more messages 108 awaiting transmission to or from one or more devices 105. The messages 108 in a service period may have the same traffic type (e.g., voice, video, data, etc.). After an access point 104 (e.g., the access point 104A) performs a service period by transmitting and/or receiving the messages 108 in the service period, the access point 104 may communicate messages 106 to other access points 104 (e.g., the access points 104B and 104C) to indicate that the service period has been performed. The other access points 104 may then use these messages 106 to update their respective data structures to indicate that the service period has been performed. In this manner, the access points 104A, 104B, and 104C update their data structures to reflect the state of the communications in the system 100.

As seen in FIG. 1, each access point 104 may include a processor 122, a memory 124, and one or more radios 126. The processor 122, the memory 124, and the one or more radios 126 may perform the functions or actions of the access points 104 described herein.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 104. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 104 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 104 may use one or more of the radios 126 for Wi-Fi communications. The access point 104 may use one or more of the radios 126 to transmit messages and one or more of the radios 126 to receive messages. The access point 104 may include any number of radios 126 to communicate using any number of communication technologies.

The access point 104 may include any number of (e.g., one or multiple) processors 122 and memories 124. Generally, one or multiple processors 122 are considered to perform an operation (or configured to perform the operation) if (i) at least one of the processors 122 individually performs every step of the operation or (ii) multiple processors 122 collectively perform the steps of the operation (e.g., if one processor 122 performs the first half of the operation and another processor 122 performs the second half of the operation). Additionally, one or multiple memories 124 are considered to perform an operation (or configured to perform the operation) if (i) at least one of the memories 124 individually performs every step of the operation or (ii) multiple memories 124 collectively perform the steps of the operation (e.g., if one memory 124 performs the first half of the operation and another memory 124 performs the second half of the operation).

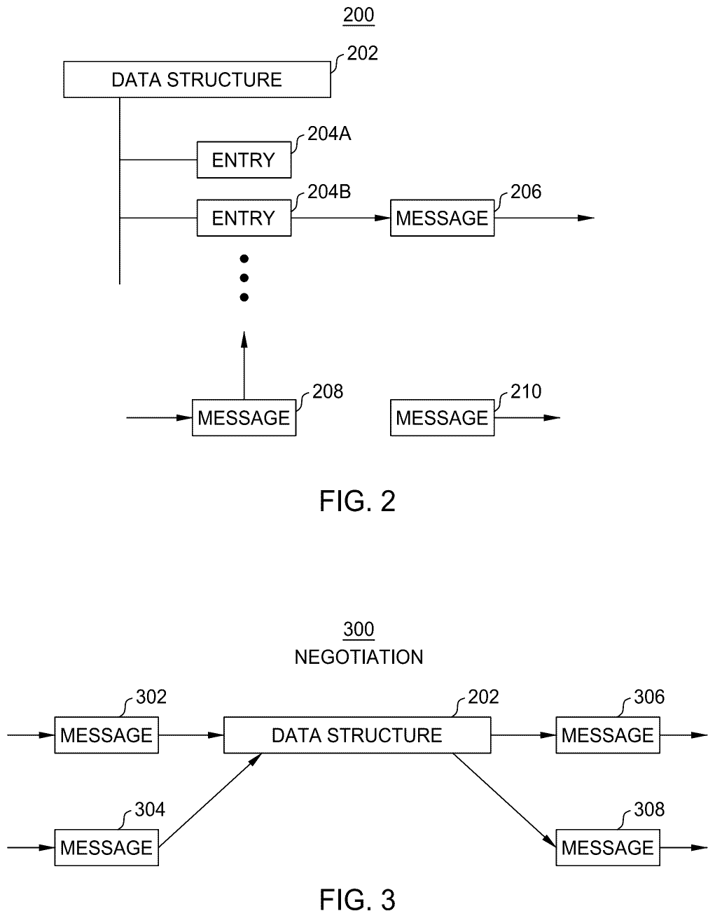

FIG. 2 illustrates an example operation 200 performed by the system 100 of FIG. 1. An access point (e.g., an access point 104 shown in FIG. 1) performs the operation 200. By performing the operation 200, the access point maintains a data structure that tracks the communication state of other, nearby access points that are assigned to other BSSs.

As seen in FIG. 2, the access point maintains a data structure 202 (which may be stored in a memory of the access point). The data structure 202 may maintain information in a structured or organized way. For example, the data structure 202 may be a bitmap, a table, a list, an array, a matrix, etc., with 1 or 2 or more dimensions. The data structure 202 holds information about the communication state of other access points near the access point. These other access points may be assigned to or service BSSs different from the BSS that the access point serves. As a result, some or all of the other access points may be managed and/or controlled separately from the access point. For example, the access point may be deployed in a store of a shopping mall, as a singleton or as one of several APs of the store, and the other access points may be deployed in other nearby stores of the shopping mall. The data structure 202 may track service periods of the access point and of the other access points that have been performed or are waiting to be performed. As a result, the data structure 202 may indicate messages at the access point and at other, nearby access points that have been transmitted or are waiting to be transmitted. The access point uses the data structure 202 to coordinate transmissions with the other, nearby access points that service other BSSs.

As seen in FIG. 2, the data structure 202 includes entries 204 (e.g., the entries 204A and 204B). The entries 204 may indicate the messages at the access point and at other, nearby access points that have been transmitted or that are awaiting transmission. The entries 204 may be organized in any way. For example, each entry 204 may indicate the messages that have been transmitted and the messages awaiting transmission at a particular access point, or one of these kinds of messages. As another example, each entry 204 may indicate the messages of a particular type (e.g., voice, video, etc.) that have been transmitted and/or awaiting transmission at a particular access point. The entries might be divided by dimensions or hierarchically: for instance by peer AP, by message type and by time-order.

The access point may transmit a message 206 according to the information in the entries 204 of the data structure 202. For example, the access point may use the information in the entries 204 to determine which message at the access point or at the other, nearby access points should be transmitted next. The access point may make this determination based on a prioritization messages and message types that was negotiated with the other, nearby access points. If the access point determines that the message 206 should be transmitted next, then the access point may transmit the message 206 while the other, nearby access points refrain from transmitting so as to not cause interference with the transmission of the message 206. Similarly, the access point may trigger the transmission of a message from a device to the access point while the other, nearby access points refrain from transmitting (or refrain from triggering transmissions from their associated devices) so as to not cause interference with the transmission of the message. In some instances, the other, nearby access points may even instruct their associated devices to not autonomously transmit during this time. If the access point determines that another, nearby access point should transmit next, then the access point may refrain from transmitting and/or the access point may refrain from triggering its associated devices from transmitting to avoid causing interference when the other, nearby access point transmits.

The access point may receive a message 208 (e.g., from another, nearby access point). The message 208 may indicate that another, nearby access point has transmitted a message or performed a service period. In response, the access point may update an entry 204 of the data structure 202 to reflect that the message has been transmitted or that the service period has been performed. Additionally, the access point may transmit the message 210 to indicate that the message at the other access point has been transmitted or that the service period at the other access point has been performed. The access point may transmit the message 210 to other, nearby access points so that these access points may update their corresponding data structures. In this manner, the access point and the other, nearby access points inform each other about message transmissions so that every access point may maintain their corresponding data structures 202.

If the access point had transmitted the message 206 or performed a service period that included the message 206, the message 210 may indicate that the access point has transmitted the message 206 or performed a service period that included the transmission of the message 206. When other, nearby access points receive the message 210, these access points may update their corresponding data structures 202 to indicate that the message 206 has been transmitted or that the service period has been performed.

In some embodiments, the messages 208 and 210 may report the state of the access points. For example, the messages 208 and 210 may report the recently performed service periods, service periods whose target service period transmission time has passed but have not yet been performed, and/or the service periods that will be performed imminently. The access points may use the information in the messages 208 and 210 to update their corresponding data structures 202.

The access point may receive the message 208 and/or transmit the message 210 over a separate communication channel than the one used to transmit the message 206. For example, the access point and the other, nearby access points may establish a communication channel separate from the communication channels that the access points use to communicate with connected user devices or stations. The message 208 and the message 210 may be communicated over this separate communication channel. In some instances the separate communication channel may be wired. In some instances the separate communication channel may be wireless and have a lower modulation coding scheme than other channels.

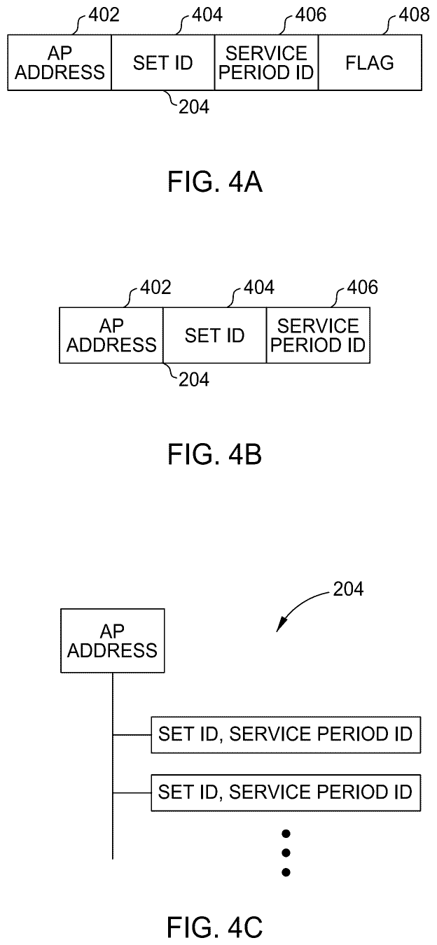

FIG. 3 illustrates an example operation 300 performed by the system 100 of FIG. 1. An access point (e.g., the access point 104 shown in FIG. 1) may perform the operation 300. By performing the operation 300, the access point negotiates message transmission order or priority with other, nearby access points.

During the negotiation, the access point may receive messages (e.g., messages 302 and 304) from other, nearby access points. The access point may also transmit messages to the other, nearby access points. The negotiation may allow the access point and the other, nearby access points to understand the messages that will need transmission and to agree on the transmission order or priority of messages. In some embodiments, the access point may negotiate the order in which service periods (which may include the transmission and/or receipt of multiple messages) are performed. After the negotiation, the access point may determine, from the data structure 202, which messages or which types of messages that are awaiting transmission have the highest transmission priority or the highest transmission order. The access point may then determine that these messages are next for transmission. In the example of FIG. 3, the access point may transmit the messages 306 and 308 if these messages 306 and 308 have the highest transmission priority. If the messages with the highest transmission priority are instead at another, nearby access point, then the access point may refrain from transmitting for a period of time until the access point receives indication that those messages have been transmitted. In some embodiments, the messages 306 and 308 may belong to a service period. If the access point determines that the service period should be performed according to the negotiated ordering of service periods, then the access point may transmit the messages 306 and 308.

The transmission priority or order may be set during the negotiation according to any parameters or characteristics. For example, the access points may agree that certain message types (e.g., voice, or voice sent via business' authorized telephony and teleconference applications and systems, etc.) should have higher transmission priority than other message types (e.g., video, or voice sent by other than the business' authorized telephony and teleconference applications and systems, etc.) or that service periods for these message types should have higher priority than service periods for other message types (e.g., to satisfy quality of service requirements). As another example, the access points may determine transmission priority based on signal strength with connected devices (e.g., better signal strength receives higher transmission priority). After the access points agree on the transmission priority, the access points coordinate transmissions according to the agreed upon transmission priority so as to avoid interfering with each other's transmissions.

For access points in the same BSS (or administrative domain), the access points may use a common set of policies to determine the transmission priority or the service period ordering. For access points in different BSSs, the access points may negotiate via a roaming policy entity (e.g., OpenRoaming) whereby nearby access points agree to honor the negotiated transmission priority or service period ordering. The agreed honoring may continue until a pre-agreed limit. The access points may then cooperate with each other by coordinating transmissions according to the negotiated transmission priority.

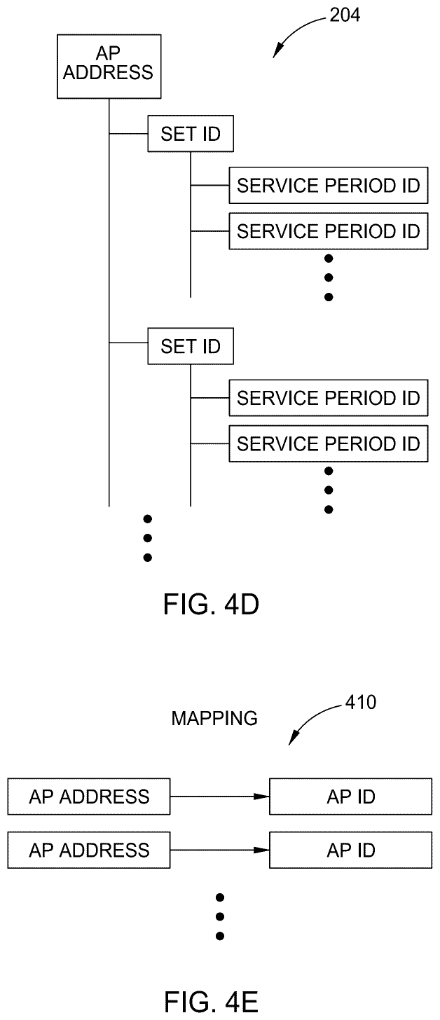

FIGS. 4A through 4D illustrate example entries 204 in the system 100 of FIG. 1. An access point (e.g., the access point 104 shown in FIG. 1) may maintain an entry 204 in a data structure. The access point may structure or organize the entry 204 in any manner to track the state of the access point and other, nearby access points. The data structure may include multiple entries that describe the state of the access point and other, nearby access points. Each of the entries may or may not have the same structure.

FIG. 4A shows an example structure for an entry 204. As seen in FIG. 4A, the entry 204 may resemble an entry of a table. The entry 204 may include multiple fields 402, 404, 406, and 408 that specify different information about messages at the access point or another, nearby access point that are awaiting transmission or that have been transmitted.

The field 402 may include an address for an access point, which serves as an identifier. For example, the field 402 may include a media access control (MAC) address or a BSS identifier for the access point or a nearby, access point. Generally, the field 402 identifies an access point for which the information in the entry 204 applies.

The field 404 includes a set identifier. Generally, the set identifier may be a value (e.g., a numerical value) that identifies a traffic type or traffic flow(s). For example, the set identifier may be a traffic identifier that identifies voice traffic, video traffic, browsing traffic, a particular voice flow, a set of voice flows with similar requirements in terms of timing, etc. The set identifier may be used to determine whether the data or messages indicated by the entry 204 are subject to quality of service requirements. In some instances, the set identifier may further indicate a priority for the service periods assigned to that set identifier. For example, set identifiers for video and voice traffic (e.g., access category) may have a higher priority than other set identifiers. There may be a finer-grained priority such as based on User Priority (UP), Traffic ID (TID), Stream Classification Service ID, or other individualization per flow.

The field 406 includes one or more service period identifiers. Generally, a service period identifier may identify one or more service periods, where each service period includes messages that have been transmitted and/or that are awaiting transmission. The entry 204 may include multiple service period identifiers for a particular set identifier. Each service period identifier may correspond with one or more messages that have been transmitted and/or that are awaiting transmission.

The field 408 includes one or more flags. Each flag may indicate whether a particular service period has been performed or not. For example, if the flag is set, then the flag may indicate that a corresponding service period (with a service identifier in or determinable from the field 406) has been performed and/or that the messages corresponding to that service period have been transmitted. If the flag is not set, then the flag may indicate that the corresponding service period has not been performed and/or that the messages corresponding to that service period have not been transmitted. The entry 204 may include a flag for each service period identifier in the field 406. In some embodiments, the field 406 contains a single service period identifier that indicate the first service period of interest, and the field 408 contains multiple flags in the form of a bitmap of some length N. The bits of the bitmap may indicate the state of the first service period of interest and subsequent N−1 service periods. For example, the first bit of the bitmap may indicate the state of the first service period of interest. The second of the bitmap may indicate the state of the service period after the first service period of interest, and so on.

FIG. 4B shows an example structure for an entry 204. As seen in FIG. 4B, the entry 204 includes the fields 402, 404, and 406 that specify different information about messages at the access point or another, nearby access point that are awaiting transmission or that have been transmitted.

The field 402 may include an address for an access point, which serves as an identifier. For example, the field 402 may include a media access control address or a BSS identifier for the access point or a nearby, access point. Generally, the field 402 identifies an access point for which the information in the entry 204 applies.

The field 404 includes a set identifier. Generally, the set identifier may be a value (e.g., a numerical value) that identifies a traffic type or traffic flow(s). For example, the set identifier may be a traffic identifier that identifies voice traffic, video traffic, browsing traffic, a particular voice flow, a set of voice flows with similar requirements in terms of timing, etc. The set identifier may be used to determine whether the data or messages indicated by the entry 204 are subject to quality of service requirements. In some instances, the set identifier may further indicate a priority for the service periods assigned to that set identifier. For example, set identifiers for video and voice traffic (e.g., access category) may have a higher priority than other set identifiers. There may be a finer-grained priority such as based on User Priority (UP), Traffic ID (TID), Stream Classification Service ID, or other individualization per flow. The field 406 includes a service period identifier. Generally, the service period identifier may identify a service period that includes messages that have been transmitted and/or that are awaiting transmission. There may be different interpretations for the service period identifier in the structure of FIG. 4B. For example, the service period identifier may identify the service period that was most recently performed. As another example, the service period identifier may identify one or more service periods that are upcoming. As another example, the service period identifier may identify the service period that was last performed successfully. As another example, the service period identifier may identify the service period immediately following the last successfully performed service period. Regardless of the interpretation, the service period identifier may provide information and some indication of the next service period to be performed.

FIG. 4C illustrates an example structure for an entry 204. As seen in FIG. 4C, the entry 204 includes a nested structure. Generally, the entry 204 includes an address for an access point (e.g., a MAC address or a BSS identifier of the access point) at the root of the entry 204. Organized beneath the root may be set identifiers (e.g., that identify a traffic type) and service period identifiers (e.g., that identify service periods) for the access point. In this manner, the entry 204 may include information about every traffic type and service period for the access point (as opposed to splitting this information across multiple entries 204).

FIG. 4D illustrates an example structure for an entry 204. As seen in FIG. 4D, the entry 204 includes a nested structure. Generally, the entry 204 includes an address for an access point (e.g., a MAC address or a BSS identifier of the access point) at the root of the entry 204. Organized beneath the root in a second tier of the nest structure may be set identifiers (e.g., that identify a traffic type) for the access point. In a third tier beneath the second tier of the nest structure may be service period identifiers (e.g., that identify service periods) of the traffic type indicated by the set identifiers. In this manner, the entry 204 may include information about every traffic type and service period for the access point (as opposed to splitting this information across multiple entries 204).

FIGS. 4E and 4F illustrate example mappings in the system 100 of FIG. 1. Generally, the access point may compress some of the fields in the structures used for the entries (e.g., the entries 204 shown in FIGS. 4A through 4D). By compressing the information in the fields, the access point may reduce the amount of memory space used to store the data structure and the entries.

FIG. 4E shows an example mapping 410 in which addresses for access points are mapped to an identifier. Generally, the identifiers may be shortened codes (e.g., numerical values) that substitute for the addresses of the access points. It may take less space to store and communicate the identifiers for the access points rather than the addresses.

The access point may store the mapping 410, and the access point may communicate the mapping 410 (e.g., in a message) to other, nearby access points. The other access points may then use the mapping 410 to determine the access point identifiers used by the access point. The access points in the system are not required to use the same mapping 410. Rather, each access point may establish its own mapping 410. Thus, different access points may refer to the same access point using different identifiers according to their own individual mappings 410. Each access point may use its own mapping 410 when communicating with a peer access point, and it is the responsibility of the peer access point to apply the mapping from identifier to access point address in order to infer the access point being reported upon. This embodiment is helpful for groupcast and individually-addressed transmissions. In another embodiment, best suited to individually-addressed transmissions, each access point may use the mapping 410 from another access point to determine the access point identifiers to use when communicating with the other access point.

FIG. 4F illustrates an example mapping 412 in which addresses for access points and set identifiers are mapped to an identifier. Generally, the identifiers may be shortened codes (e.g., numerical values) that substitute for the addresses of the access points and the set identifiers. It may take less space to store and communicate the identifiers rather than the addresses for the access points and the identifiers.

The access point may store the mapping 412, and the access point may communicate the mapping 412 (e.g., in a message) to other, nearby access points. The other access points may then use the mapping 412 to determine the identifiers used by the access point to refer to the access point addresses and set identifiers. The access points in the system are not required to use the same mapping 412. Rather, each access point may establish its own mapping 412. Thus, different access points may refer to the same access point and set identifier using different identifiers according to their own individual mappings 412. Each access point may use its own mapping 412 when communicating with a peer access point, and it is the responsibility of the peer access point to apply the mapping from identifier to access point address and set identifier in order to infer the access point and set identifier being reported upon. This embodiment is helpful for groupcast and individually-addressed transmissions. In another embodiment, best suited to individually-addressed transmissions, each access point may use the mapping 412 from another access point to determine the access point identifiers and set identifiers to use when communicating with the other access point.

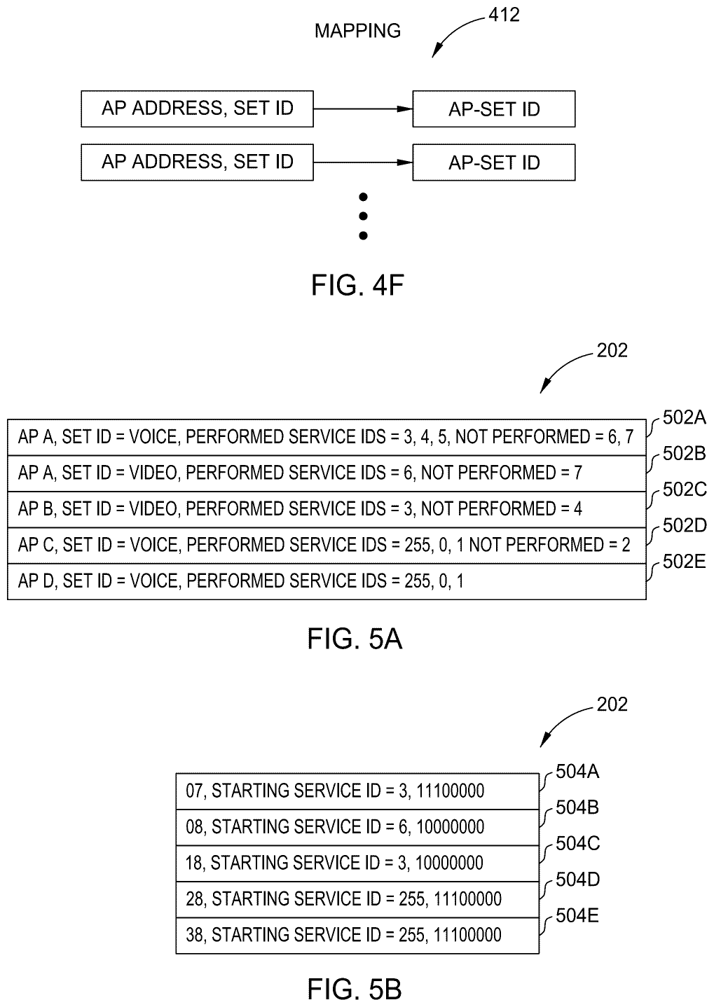

FIGS. 5A through 5C illustrate example data structures 202 in the system 100 of FIG. 1. Each of the examples in these figures may use different structures for the data structure 202 to indicate the same communication state in the system 100.

In the example of FIG. 5A, the data structure 202 includes entries 502A, 502B, 502C, 502D, and 502E. These entries may include information for the access points A, B, C, and D. These access points may be assigned to different BSSs, but the access points may be positioned near each other.

The entry 502A indicates that for voice traffic at access point A, the service periods with the identifiers 3, 4, and 5 have been performed (e.g., the messages for these service periods have been transmitted) and the service periods with the identifiers 6 and 7 have not been performed (e.g., the messages for these service periods have not been transmitted). The entry 502B indicates that for video traffic at access point A, the service period with the identifier 6 has been performed and the service period with the identifier 7 has not been performed. The entry 502C indicates that for video traffic at access point B, the service period with the identifier 3 has been performed and the service period with the identifier 4 has not been performed. The entry 502D indicates that for voice traffic at access point C, the service periods with the identifiers 255, 0, and 1 have been performed and the service period with the identifier 2 has not been performed. The entry 502E indicates that for voice traffic at access point D, the service periods with the identifiers 225, 0, and 1 have been performed.

In the example of FIG. 5B, the data structure 202 includes entries 504A, 504B, 504C, 504D, and 504E. Generally, the entries 504 use different techniques to compress the information shown in the entries 502A, 502B, 502C, 502D, and 502E shown in FIG. 5A. For example, the entries 504A, 504B, 504C, 504D, and 504E may replace the access point identifier and the set identifier with a numerical code. Additionally, the entries 504A, 504B, 504C, 504D, and 504E may use a bitmap to indicate which service periods have been performed or not performed (e.g., with reference to a starting service period identifier).

The entry 504A compresses the access point identifier for access point A and the set identifier for voice traffic into a numerical code 07. Additionally, the entry 504A includes a starting service identifier of 3 and a bitmap of ‘11100000’. This encoding indicates that (i) the leftmost bit of the bitmap (‘1’) indicates that the service period with the identifier 3 has been performed, (ii) the second leftmost bit of the bitmap (‘1’) indicates that the service period with the identifier 4 has been performed, (iii) the third leftmost bit of the bitmap (‘1’) indicates that the service period with the identifier 5 has been performed, and (iv) the next five bits (‘00000’) indicate that the service periods with the identifiers 6, 7, 8, 9, and 10 have not been performed.

The entry 504B compresses the access point identifier for access point A and the set identifier for video traffic into a numerical code 08. Additionally, the entry 504B includes a starting service identifier of 6 and a bitmap of ‘10000000’. This encoding indicates that (i) the leftmost bit of the bitmap (‘1’) indicates that the service period with the identifier 6 has been performed and (ii) the next seven bits (‘0000000’) indicate that the service periods with the identifiers 7, 8, 9, 10, 11, 12, 13 have not been performed.

The entry 504C compresses the access point identifier for access point B and the set identifier for video traffic into a numerical code 18. Additionally, the entry 504C includes a starting service identifier of 3 and a bitmap of ‘10000000’. This encoding indicates that (i) the leftmost bit of the bitmap (‘1’) indicates that the service period with the identifier 3 has been performed and (ii) the next seven bits (‘0000000’) indicate that the service periods with the identifiers 4, 5, 6, 7, 8, 9, 10 have not been performed.

The entry 504D compresses the access point identifier for access point C and the set identifier for voice traffic into a numerical code 28. Additionally, the entry 504D includes a starting service identifier of 255 and a bitmap of ‘11100000’. This encoding indicates that (i) the leftmost bit of the bitmap (‘1’) indicates that the service period with the identifier 255 has been performed, (ii) the second leftmost bit of the bitmap (‘1’) indicates that the service period with the identifier 0 has been performed, (iii) the third leftmost bit of the bitmap (‘1’) indicates that the service period with the identifier 1 has been performed, and (iv) the next five bits (‘00000’) indicate that the service periods with the identifiers 2, 3, 4, 5 and 6 have not been performed.

The entry 504E compresses the access point identifier for access point D and the set identifier for voice traffic into a numerical code 38. Additionally, the entry 504D includes a starting service identifier of 255 and a bitmap of ‘11100000’. This encoding indicates that (i) the leftmost bit of the bitmap (‘1’) indicates that the service period with the identifier 255 has been performed, (ii) the second leftmost bit of the bitmap (‘1’) indicates that the service period with the identifier 0 has been performed, (iii) the third leftmost bit of the bitmap (‘1’) indicates that the service period with the identifier 1 has been performed, and (iv) the next five bits (‘00000’) indicate that the service periods with the identifiers 2, 3, 4, 5 and 6 have not been performed.

In the example of FIG. 5C, the data structure 202 includes entries 506A, 506B, 506C, and 506D. Generally, the entries 506 use different techniques to compress the information shown in the entries 502A, 502B, 502C, 502D, and 502E shown in FIG. 5A. For example, the entries 506A, 506B, 506C, and 506D may replace the access point identifier and the set identifiers for voice and video traffic with a numerical code. Additionally, the entries 506A, 506B, 506C, and 506D may use bitmaps to indicate which service periods for each set have been performed or not performed. Furthermore, the entries 506A, 506B, 506C, and 506D may use a nested structure for the access points and the set identifiers. Moreover, the entries 506A, 506B, 506C, and 506D may include information for service identifiers for multiple traffic types or flows such as is shown: video and voice traffic.

The entry 506A compresses the access point identifier for access point A and the set identifiers for voice and video traffic into a numerical code 07. For voice traffic, the entry 506A includes a starting service identifier of 3 and a bitmap of ‘11100000’. This encoding indicates that (i) the leftmost bit of the bitmap (‘1’) indicates that the service period with the identifier 3 has been performed, (ii) the second leftmost bit of the bitmap (‘1’) indicates that the service period with the identifier 4 has been performed, (iii) the third leftmost bit of the bitmap (‘1’) indicates that the service period with the identifier 5 has been performed, and (iv) the next five bits (‘00000’) indicate that the service periods with the identifiers 6, 7, 8, 9, and 10 have not been performed. For video traffic, the entry 506A includes a starting service identifier of 6 and a bitmap of ‘10000000’. This encoding indicates that (i) the leftmost bit of the bitmap (‘1’) indicates that the service period with the identifier 6 has been performed and (ii) the next seven bits (‘0000000’) indicate that the service periods with the identifiers 7, 8, 9, 10, 11, 12, 13 have not been performed.

The entry 506B compresses the access point identifier for access point B and the set identifiers for voice and video traffic into a numerical code 18. For voice traffic, the entry 506B includes a starting service identifier of 0 and a bitmap of ‘00000000’. This encoding indicates that there are no service periods (or at least no service periods any time soon) for voice traffic. For video traffic, the entry 506B includes a starting service identifier of 3 and a bitmap of ‘10000000’. This encoding indicates that (i) the leftmost bit of the bitmap (‘1’) indicates that the service period with the identifier 3 has been performed and (ii) the next seven bits (‘0000000’) indicate that the service periods with the identifiers 4, 5, 6 7, 8, 9 and 10 have not been performed.

The entry 506C compresses the access point identifier for access point C and the set identifiers for voice and video traffic into a numerical code 28. For voice traffic, the entry 506C includes a starting service identifier of 3 and a bitmap of ‘11100000’. This encoding indicates that (i) the leftmost bit of the bitmap (‘1’) indicates that the service period with the identifier 3 has been performed, (ii) the second leftmost bit of the bitmap (‘1’) indicates that the service period with the identifier 4 has been performed, (iii) the third leftmost bit of the bitmap (‘1’) indicates that the service period with the identifier 5 has been performed, and (iv) the next five bits (‘00000’) indicate that the service periods with the identifiers 6, 7, 8, 9, and 10 have not been performed. For video traffic, the entry 506C includes a starting service identifier of 0 and a bitmap of ‘00000000’. This encoding indicates that there are no service periods (or at least no service periods any time soon) for video traffic.

The entry 506D compresses the access point identifier for access point D and the set identifiers for voice and video traffic into a numerical code 38. For voice traffic, the entry 504D includes a starting service identifier of 3 and a bitmap of ‘11100000’. This encoding indicates that (i) the leftmost bit of the bitmap (‘1’) indicates that the service period with the identifier 3 has been performed, (ii) the second leftmost bit of the bitmap (‘1’) indicates that the service period with the identifier 4 has been performed, (iii) the third leftmost bit of the bitmap (‘1’) indicates that the service period with the identifier 5 has been performed, and (iv) the next five bits (‘00000’) indicate that the service periods with the identifiers 6, 7, 8, 9, and 10 have not been performed. For video traffic, the entry 506C includes a starting service identifier of 0 and a bitmap of ‘00000000’. This encoding indicates that there are no service periods (or at least no service periods any time soon) for video traffic.

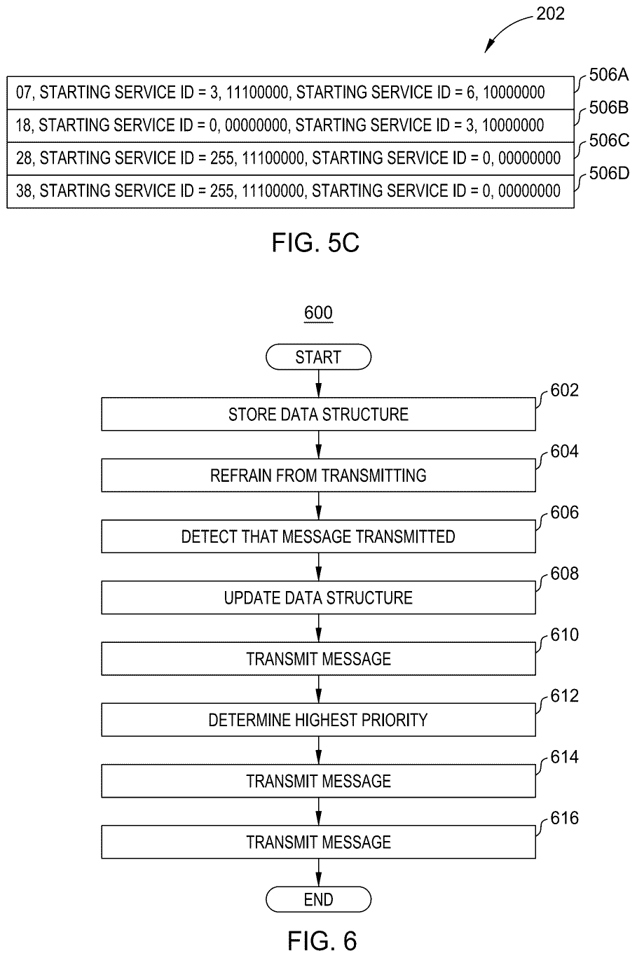

FIG. 6 is a flowchart of an example method 600 performed by the system 100 of FIG. 1. In certain embodiments, an access point (e.g., the access point 104 shown in FIG. 1) performs the method 600. By performing the method 600, the access point uses a data structure (e.g., an array, table, etc.) that tracks the communication state of the system 100 to coordinate transmissions between or amongst access points assigned to different BSSs.

At 602, the access point stores the data structure. The data structure may be a scoreboard with entries that indicate the communication state of the access point and other, nearby access points. Each entry may indicate the nearby-in-time service periods that have been performed and/or that have not been performed (e.g., the messages that have been transmitted or are awaiting transmission). Thus, the data structure indicates the communication state of the access point and the other, nearby access points.

At 604, the access point refrains from transmitting a message for a period of time. For example, the access point may determine, from the data structure, that a service period at another access point should be performed next. In response, the access point refrains from transmitting the message to avoid interfering with the transmission at the other access point.

At 606, the access point detects that a message at the other access point has been transmitted (e.g., that the service period has been performed). For example, the access point may receive a message from the other access point indicating that the service period has been performed. At 608, the access point updates the data structure to indicate that the service period at the other access point has been performed.

At 610, the access point transmits a message to other, nearby access points to report the update to the data structure. For example, the message may indicate that the service period at the other access point has been performed. The other, nearby access points may use this message to update their respective data structures.

At 612, the access point may determine that the access point has the highest transmission priority. For example, the access point may reference the updated data structure and determine that the service period at the access point should be performed next. At 614, the access point may transmit a message (e.g., the message that the access point refrained from transmitting at 604) and/or perform a service period. At 616, the access point may then transmit or broadcast a message to report to other, nearby access points that the access point has transmitted and/or performed a service period. The access point may also update its own data structure accordingly.

In summary, the system 100 includes wireless networks that coordinate transmissions across different BSSs. Generally, the access points in a network maintain a data structure (e.g., a scoreboard) that tracks the sequence of one or more related transmissions and/or triggering of transmissions (which sequence may also be referred to as a service period) of access points in other BSSs. When an access point completes a service period, the access point may inform nearby access points in other BSSs that the service period has been completed. These access points may then update their data structure to reflect that the service period has been completed. In this manner, the access points in different BSSs may use the data structures to track and monitor the state of the transmission medium. For example, the access points may determine what messages/service periods from other BSSs have been completed or are still upcoming. These access points may coordinate their service periods using the data structure, which reduces the interference between the access points and helps low latency traffic across access points to be delivered promptly with higher reliability.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the users computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A first access point arranged to be assigned to a first basic service set, the first access point comprising:
one or more memories configured to, individually or collectively, store a data structure comprising a first entry, wherein the first entry indicates (i) a second access point assigned to a second basic service set different from the first basic service set, (ii) a first message at the second access point that has not been transmitted; and
one or more processors communicatively coupled to the one or more memories, the one or more processors configured to, individually or collectively, perform an operation comprising:
refraining, based on the first entry, from transmitting a second message for a period of time;
in response to detecting that the second access point transmitted the first message, updating the first entry to indicate that the first message has been transmitted; and
transmitting, to the second access point, a third message indicating that the first message has been transmitted.

2. The first access point of claim 1, wherein the operation further comprises transmitting the second message after the period of time and wherein the third message further indicates that the second message has been transmitted.

3. The first access point of claim 1, wherein the first entry indicates the second access point using at least one of a media access control address of the second access point or an identifier of the second basic service set.

4. The first access point of claim 1, wherein the operation further comprises assigning an identifier to the second access point, wherein the first entry indicates the second access point using the identifier.

5. The first access point of claim 4, wherein the operation further comprises transmitting, to the second access point, a fourth message indicating the identifier.

6. The first access point of claim 4, wherein the identifier further indicates at least one of a traffic type or flow for the first message.

7. The first access point of claim 1, wherein the first entry indicates that the first message has not been transmitted using a bitmap.

8. The first access point of claim 1, wherein the first entry further indicates a priority of the first message and wherein refraining from transmitting the second message is based on the priority.

9. The first access point of claim 1, wherein the operation further comprises establishing a communication channel with the second access point and wherein the third message is transmitted using the communication channel.

10. The first access point of claim 1, wherein the first entry indicates the first message at the second access point that has not been transmitted by identifying a service period at the second access point that has not been performed.

11. The first access point of claim 1, wherein the first entry indicates that the first message has not been transmitted by at least one of the second access point or a device associated with the second access point.

12. The first access point of claim 1, wherein the operation further comprises refraining from triggering a device from transmitting a message during the period of time.

13. The first access point of claim 1, wherein the period of time ends in response to detecting that the second access point transmitted the first message.

14. A method comprising:
storing, by a first access point assigned to a first basic service set, a data structure comprising a first entry, wherein the first entry indicates (i) a second access point assigned to a second basic service set different from the first basic service set, (ii) a first message at the second access point that has not been transmitted;
refraining, by the first access point and based on the first entry, from transmitting a second message for a period of time;
in response to detecting that the second access point transmitted the first message, updating, by the first access point, the first entry to indicate that the first message has been transmitted; and
transmitting, by the first access point and to the second access point, a third message indicating that the first message has been transmitted.

15. The method of claim 14, further comprising transmitting, by the first access point, the second message after the period of time and wherein the third message further indicates that the second message has been transmitted.

16. The method of claim 14, wherein the first entry indicates the second access point using at least one of a media access control address of the second access point or an identifier of the second basic service set.

17. The method of claim 14, further comprising assigning, by the first access point, an identifier to the second access point, wherein the first entry indicates the second access point using the identifier.

18. The method of claim 17, further comprising transmitting, by the first access point and to the second access point, a fourth message indicating the identifier.

19. The method of claim 17, wherein the identifier further indicates at least one of a traffic type or flow for the first message.

20. A non-transitory computer readable medium storing instructions that, when executed by one or more processors, cause the one or more processors to, individually or collectively, perform an operation comprising:
storing, by a first access point assigned to a first basic service set, a data structure comprising a first entry, wherein the first entry indicates (i) a second access point assigned to a second basic service set different from the first basic service set, (ii) a first message at the second access point that has not been transmitted;
refraining, by the first access point and based on the first entry, from transmitting a second message for a period of time;
in response to detecting that the second access point transmitted the first message, updating, by the first access point, the first entry to indicate that the first message has been transmitted; and
transmitting, by the first access point and to the second access point, a third message indicating that the first message has been transmitted.
